(19) United States
(12) Patent Application Publication
(10) Pub. No.: US 2022/0372798 A1
(43) Pub. Date: Nov. 24, 2022

(54) METHOD FOR PERFORMING A FUNCTIONAL MOVEMENT OF A SECONDARY FUNCTION OF AN ELECTRIC DOOR HANDLE

(71) Applicant: HS Products Engineering GmbH, Maisach (DE)

(72) Inventor: Niklas Christopher GRÖVER, München (DE)

(73) Assignee: HS Products Engineering GmbH, Maisach (DE)

(21) Appl. No.: 17/749,186

(22) Filed: May 20, 2022

(30) Foreign Application Priority Data
May 20, 2021 (DE) 10 2021 205 151.0

(51) Int. Cl. E05B 77/34; E05B 85/10

(52) U.S. Cl. CPC E05B 77/34; E05B 85/107; E05B 85/103

(57) ABSTRACT

The present invention relates to a method for performing an alternating functional movement for producing a secondary function with a hand grip (30) of an electric door handle (10) of a vehicle door (100), comprising the following steps:
receiving a function request (FA) for activating the secondary function,
performing the alternating functional movement, wherein the hand grip (30) is moved back and forth multiple times between at least two different functional positions (FUP).

### RELATED APPLICATION

This application claims the benefit of priority under of Germany Patent Application No. 10 2021 205 151.0 filed on May 20, 2021, the contents of which are incorporated by reference as if fully set forth herein in their entirety.

### FIELD AND BACKGROUND OF THE INVENTION

The present invention relates to a method for performing an alternating functional movement of a secondary function of an electric door handle of a vehicle door and to an electric door handle for a vehicle door comprising a control device for carrying out a method of this kind.

It is known that vehicle doors of vehicles are equipped with hand grips in order to comfortably open and close the vehicle doors. Electric door handles of this kind typically comprise a hand grip, which can be gripped by the hand of the user of the door handle. Typically, the hand grips are also equipped with an unlocking function, such that the vehicle door can be unlocked for subsequent opening when an unlocking movement is performed. It is also known that door handles of this kind are designed to be electric, i.e. they can be moved back and forth between a retracted travel position and an extended gripping position by means of an electric drive, in particular.

A disadvantage of the known solutions, in particular electric door handles, is that they are difficult to grip in the event of icing. This is in particular due to the fact that, when moving the electric handle out of the travel position and into a gripping position, a higher force is required in order to be able to blast away a crust of ice on the handle in the form of a layer of ice. To make this possible, the hand grip or entire electric door handle must be designed in an extremely solid and mechanically stable manner. This results in a large amount of design work, and thus to higher material consumption, higher costs and also an increased weight.

An object of the present invention is to overcome the above-described disadvantages at least in part. In particular, an object of the present invention is to provide a secondary function, in particular for de-icing the hand grip, for an electric door handle in a simple and cost-effective manner.

The above-mentioned object is achieved by a method having the features of claim 1 and by an electric door handle having the features of claim 15. Other features and details of the invention are apparent from the dependent claims, the description and the drawings. Features and details that are described in connection with the method according to the invention naturally also apply in connection with the electric door handle according to the invention and vice versa, and therefore reference is or can always be made interchangeably to the disclosure of the individual aspects of the invention.

### SUMMARY OF THE INVENTION

According to the invention, a method is proposed for performing an alternating functional movement for producing a secondary function with a hand grip of an electric door handle of a vehicle door. A method of this kind comprises the following steps:
receiving a function request for activating the secondary function,
performing the alternating functional movement, wherein the hand grip is moved back and forth multiple times between at least two different functional positions.

In addition, the following step, in particular, may also be performed before or after the function request is received:
determining a current position of the hand grip within a range of movement between a first mechanically defined end position and a second mechanically defined end position.

Within the context of the present invention, a vehicle door should be understood to mean any form of component that reversibly closes a vehicle opening. In particular, this also includes boot lids, frunk lids, bonnets or the like.

The core idea of the invention is that a secondary function can be provided with the hand grip of an electric door handle. The secondary function differs from the primary function of the hand grip, i.e. the opening function and/or locking function. An example of a secondary function of this kind is a de-icing function, i.e. the removal or partial removal of a blocking layer of ice in the region of the hand grip of the electric door handle.

According to the invention, in order to produce this secondary function with the hand grip, an alternating functional movement is performed. This should be understood to mean that the hand grip is moved back and forth in an alternating manner, i.e. multiple times, between at least two different functional positions. These functional positions may both be different from the mechanically defined end positions. However, it is also possible for one or even both functional positions to be identical or substantially identical to the defined end positions.

The core idea of the invention is therefore that the secondary function is based on a functional movement of the hand grip. This functional movement is not a functional movement performed once between two movement positions, but rather a movement performed multiple times in an alternating manner back and forth between the functional positions. As will be explained in more detail below, this alternating functional movement may be performed both in a regular manner, in particular in a frequency-dependent manner, and in an irregular manner.

Within the context of the present invention, a function request is the receipt of a signal for performing the secondary function. A function request of this kind may, for example, be actively given by a user, in that said user issues a signal to a corresponding control device of the electric door handle. However, other triggering function requests are also conceivable, for example the detection of a layer of ice that is lying over the hand grip and that is to be removed. Function triggering of this kind can also be understood as an internal function request within the electric door handle. Of course, the function request may also be transmitted to the electric door handle from outside, for example from the vehicle or a control module of the vehicle.

The optional determination of the current position of the hand grip should be understood to mean direct as well as indirect determination of said position. For example, the current angular position based on an electric drive device for said hand grip can be used as the basis for the current position of the hand grip. Furthermore, the last position that was moved to is, in principle, also conceivable here as the starting position or current position.

According to the invention, it is therefore possible to additionally provide a secondary function for this hand grip of the electric door handle, in particular in an existing design of an electric door handle. This secondary function differs from the primary function of opening and unlocking explained above and can serve a secondary use, for example de-icing of the hand grip. Of course, other secondary uses are additionally or alternatively possible as the secondary function, such as those explained in more detail below.

It may be advantageous if, in a method according to the invention, the secondary function is at least one of the following:
de-icing of the hand grip,
haptic signalling to the user of the hand grip,
acoustic signalling to the surroundings of the vehicle.

The list given above is not exhaustive. For de-icing the hand grip, it becomes possible, for example, for the hand grip to be in contact with the layer of ice or to be moved into a start position in order to contact the layer of ice. The subsequently performed functional movement, which is in particular alternating and frequency-dependent, results in the layer of ice itself being caused to rock back and forth, in particular vibrate, and in this way cracking and being easily removable or even dropping off by itself. Additionally or alternatively, haptic signals are also possible as the secondary functions, i.e. for example when the user of the vehicle has gripped the hand grip in a gripping position. Here, it is possible in this gripped situation to shift the hand grip into an alternating functional movement and, in this way, to transmit a vibration signal to the hand of the user, for example. Another possibility for a secondary function within the scope of the present invention is acoustic signalling to the surroundings of the vehicle. An acoustic output may take place by means of the vibration of the hand grip and/or a vibration of surrounding components, in particular if a frequency-dependent alternating functional movement is used. This output of acoustic vibration signals may, for example, be used to protect pedestrians at slow speeds of electric vehicles. Acoustic signalling, such as an addition to an alarm system, to robbery protection to the outside, or to a warning function to the inside of the vehicle, is also possible as the secondary function. For example, part of the outer skin of the vehicle and/or part of the inner lining of the vehicle may be caused to vibrate by means of an alternating functional movement of the hand grip in order to be able to provide the acoustic signal function to the outside and/or to the inside.

Additional advantages can be achieved if, in a method according to the invention, the alternating functional movement moves the hand grip back and forth between the at least two different functional positions at a defined functional frequency and/or a defined functional amplitude. In this connection, the functional frequency and/or functional amplitude may be fixed or variable. In particular, the level of the frequency and the strength of the amplitude are adapted to the relevant secondary function. If, for example, a layer of ice is to be removed, the alternating functional movement can be performed preferably with a high functional frequency and low functional amplitude. Of course, the functional amplitude may also be adapted to the maximum freedom of movement, for example in the case of a blocked movement due to a layer of ice.

Additional advantages can be achieved if, in a method according to the invention, the functional frequency and/or the functional amplitude changes over the course of the functional movement. This may take place regularly, continuously, but also irregularly and/or incrementally. This variation of the functional frequency and/or functional amplitude can also be referred to as a so-called sweep. This makes it possible for the alternating functional movement to excite different frequencies over a frequency range and thus to include, in particular, natural vibrations of a layer of ice or other components. This increases the excitation and thus optimises the effect of the relevant desired secondary function.

It may also be advantageous if, in a method according to the invention, the functional movement is divided into a first partial functional movement, in which the hand grip is moved back and forth multiple times between two different functional movements, and a second partial functional movement, in which the hand grip is moved back and forth multiple times between two different functional positions which differ from at least one functional position of the first partial functional movement. It is therefore possible for the functional movement to be designed in as complex a manner as desired. If, for example, a blocking layer of ice is detected over the hand grip, the alternating functional movement of the first partial functional movement can take place away from said layer of ice. This makes it possible for an air pocket to form between the layer of ice and the surface of the hand grip. As soon as this happens, the second partial functional movement takes place, which is directed outwardly, such that after a layer of ice becomes detached from the surface of the hand grip, the layer of ice can accordingly break away or be blasted away outwards on account of the alternating functional movement. Of course, this is also possible with a different design for the above-mentioned sweep, i.e. for the functional frequency and/or functional amplitude.

It is also advantageous if, in a method according to the invention, the alternating functional movement generates a vibration of the hand grip between at least two different functional positions. A “vibration” should preferably be understood to mean a frequency-dependent and, in particular, regular functional movement. Here, preferably high frequencies are preferred in order to ensure that the vibration is transferred accordingly to a layer of ice or to neighbouring components. Since a vibration is typically also acoustically perceivable in the surroundings of the electric hand grip, a targeted variation of the vibration can even be used to perform melodic audio signalling in the surroundings.

It is also advantageous if, in a method according to the invention, the hand grip is moved into a start position before the alternating functional movement is performed. If, for example, a layer of ice that is blocking extension of the hand grip is lying over an electric door handle, a start position may, for example, constitute actively producing contacting between the surface of the hand grip and the inner surface of the layer of ice. A start position of this kind can also be defined using a force measurement and be designed to be variable, i.e. when the hand grip extends until the force increases without further movement of the hand grip. A start position of this kind may additionally or alternatively constitute pulling off or in away from a layer of ice in order to provide a swivel range over which the hand grip can gain momentum in order to strike the layer of ice and blast same away. The approach of a mechanical end position is also possible as a start position of this kind, in particular if a vibration is produced by the alternating functional movement and is to be transferred to the housing and/or neighbouring components of the vehicle door.

Advantages are also produced if, in a method according to the invention, the alternating functional movement is performed again after the alternating functional movement is performed, in particular after a wait time. As such, repeated ice-breaking is performed or rather the secondary function is performed repeatedly. A subsequent succession of different secondary functions, in this case with differently designed alternating functional movements, is of course also possible within the scope of the present invention. In addition, a test movement may be performed between the two functional movements, i.e. in particular during the wait time, in order to check whether the layer of ice is still present or if the first round of the functional movement was successful.

Additional advantages can be achieved if, in the method according to the previous paragraph, at least one movement parameter is changed for the subsequent alternating functional movement, in particular one of the following parameters:
at least one functional position,
the movement frequency,
the movement amplitude,
the movement direction.

The list given above is not exhaustive. For example, it is possible, depending on the success or partial success or failure of the first alternating functional movement, to perform the second alternating functional movement differently, in order to make a new attempt at potentially successfully removing a layer of ice. This is, in particular, correlated with an intermediate measurement movement or test movement for whether or not the de-icing in the first step was successful. For example, after a first de-icing attempt, a test movement may be performed as the secondary function with the intention of moving the hand grip into a gripping position. If this is possible, the de-icing was successful and the alternating functional movement does not need to be performed again. If this is not possible, because a movement is not possible in spite of a force increase, the alternating functional movement is performed again, in particular with a different amplitude and/or frequency. Of course, in particular after a measurement movement of this kind has been performed, the successful combination of movement parameters can be saved and reused for future runs of the method.

It is also advantageous if, in a method according to the invention, a test movement takes place with the hand grip for receiving the function request. For example, the above-mentioned extension attempt and the detection of a blockade caused by a layer of ice are possible. An attempted retraction is also conceivable in order, for example, to detect adhesion of a layer of ice that is preventing such a retraction. Of course, significantly more complex test movements can also be used within the scope of the present invention.

Additional advantages can be achieved if, in a method according to the invention, a plausibility check, in particular using environmental parameters and/or vehicle parameters, takes place before the alternating functional movement is performed. For example, information about the evolution of the ambient temperature, the temporal progression of the air humidity in the surroundings, the temporal progression of precipitation in the surroundings or the like can be provided in order to check the plausibility of the presence of a layer of ice. In the process, vehicle sensors and weather information from the internet can be used. Of course, optical information, for example based on camera images of the vehicle, for example by means of digital rear-view mirrors, may also be used in addition to pure sensor parameters.

Furthermore, it may be advantageous if, in a method according to the invention, the alternating functional movement corresponds at least in part to a natural frequency of a neighbouring component and/or a layer of ice. The use of an alternating functional movement with a specific vibration at a natural frequency results in significantly increased and targeted excitation of the desired component or the layer of ice. This enhances and thus proportionally improves the advantages according to the invention achieved with the secondary function. If, for example, a neighbouring component is excited by means of natural frequency when the door is iced up, this can result in not only the part of the layer of ice that is in direct contact with the hand grip being acted upon, but rather a significantly larger area of action can be provided on the layer of ice on account of surrounding sheet metal parts vibrating as well. This can go so far that a window frame of the vehicle is also caused to vibrate, such that any possible icing of the window, in particular in the case of frameless windows of a vehicle, can also be effectively reversed.

Additional advantages can be achieved if, in a method according to the invention, the functional movement is simultaneously and/or subsequently also performed on other electric door handles of the vehicle. Therefore, taking the example of icing, the other vehicle doors can also be de-iced at the same time or one after the other, for example after approval by the user. In particular, this takes place automatically and preferably in the same manner as successfully provided for the first electric door handle.

Additional advantages can be achieved if, in a method according to the invention, the functional movements for at least two electric door handles differ from one another. Different and door-specific signalling can be provided in this embodiment, in particular if an acoustic and/or haptic signalling function is desired. It is even possible to provide a different vibration melody that passes around the vehicle by means of different vibration frequencies.

Another object of the present invention is an electric door handle for a vehicle door. This electric door handle comprises a main body for arrangement in the vehicle door, wherein a hand grip is mounted on the main body so as to be movable within a range of movement between a mechanically defined end position and a mechanically defined second end position by means of a handle bearing. In addition, the electric door handle comprises a control device for carrying out a method according to the invention by means of a determining module, a receiving module and a performing module. The mechanical part of an electric door handle of this kind and the function thereof will be explained in more detail below as part of the present invention.

According to the invention, an electric door handle for a vehicle door is proposed, which door handle is equipped with a main body for arrangement in the vehicle door. A hand grip is mounted on the main body so as to be movable within a range of movement, wherein the range of movement extends between a mechanically defined first end position and a mechanically defined second end position and the movability is ensured by means of a handle bearing. Furthermore, the electric door handle comprises an electric drive for a movement of the hand grip between the two end positions. The position of the hand grip between the two end positions can be determined by means of at least one sensor means. The electric drive is equipped with a transmission device for load-free positioning of the hand grip in a gripping position of the hand grip at a distance from the end positions and for load-free positioning of the hand grip in a travel position at a distance from the end positions and at a distance from the gripping position.

An electric door handle according to the invention is based on the core idea that the electric door handle is designed for an electrically performed movement. In particular, a distinction should be made between two functional positions. Firstly, there is the travel position, i.e. the position in which the hand grip is arranged when the vehicle is in a state of travel. Secondly, there is the gripping position, in which a user of the electric door handle can grip the hand grip and then open the door. In the simplest case, this is passive gripping, wherein the action of pulling results in an opening movement of the vehicle door. However, as will be explained in more detail below, the gripping may also be an active gripping, in order to trigger and/or perform an unlocking procedure of the vehicle door prior to the opening movement of the vehicle door.

The possible movements of the hand grip extend between the first end position and the second end position, which are mechanically defined and, for example, may comprise the other stops explained in more detail below.

A core idea of the invention is that at least two of the described functional positions, namely the travel position on the one hand and the gripping position on the other hand, can be set in a load-free manner by means of an electric drive via the transmission device. In other words, the electric drive alone and, in particular, independently of additional mechanical components, can position the hand grip in the travel position and in the gripping position. The only force that acts on the hand grip in the travel position and gripping position is a holding force of the electric drive, which holds the hand grip in the corresponding functional position. In contrast to known solutions, no separate switching elements, mechanical elements or kinematic lever elements are required here in order to assume and hold these positions.

A variety of advantages are achieved due to the fact that the hand grip can now be positioned at least in the functional positions of the travel position and the gripping position solely using the electric drive via the transmission device.

A first advantage is that the choice of position can be provided substantially as desired on account of the load-free nature of the positioning. As such, a different travel position and/or a different gripping position can be moved to, for example, for different vehicles, different users of the vehicle and for different vehicle doors. The free selectability therefore makes it possible to customise an electric door handle of this kind or to use said door handle as a superordinate structural module for a variety of different vehicles and then to specify and/or calibrate said door handle in a controlled manner. It is therefore possible to provide a compact modular component as an electric door handle that can be used in a customised manner in different vehicles.

Another significant advantage provided by the load-free positioning is that a mechanical correlation is no longer required for the opening mechanism and/or the unlocking mechanism of the vehicle door. Rather, it is sufficient if the door is unlocked and/or opened by a separate, in particular purely electrically operated, opening and/or unlocking mechanism. The opening and/or unlocking is then triggered if the at least one sensor means determines that the hand grip is positioned in a manner relevant for the unlocking request or the opening request. In addition to a higher degree of variability and flexibility for the use of the electric door handle, the electric door handle can also be integrated in a vehicle so as to be smaller, in a simpler manner and thus more cost-effectively on account of the fact that a mechanical correlation or additional microswitches are dispensed with.

Finally, it should also be noted that different profiles in the movement characteristics of the electric door handle can also be set by means of an electric door handle according to the invention. In particular, if counterforces are to be applied by the electric drive to the hand grip during an activation movement for unlocking the door handle, they can be set substantially as desired. For example, the user can move the hand grip out of the gripping position and into an unlocking position in order to unlock a vehicle door. For this movement, the user introduces an activation force into the hand grip. The electric drive can then apply a counterforce in a variable and freely adjustable manner such that the ease and/or heaviness of this movement can be set substantially as desired. If the vehicle on which the electric door handle is fitted is a large SUV, for example, a heavy characteristic for this movement and, accordingly, a high counterforce may be desired in order to suit the vehicle. If the vehicle is a compact vehicle, for example, a lower counterforce is possible, again to match the specific vehicle type, which lower counterforce is perceived by the user as a slick movement of the hand grip from the gripping position into the unlocking position.

As is apparent from the explanation given above, the electric door handle is designed so as to be free from a mechanically defined zero position and can in particular be positioned in the above-mentioned two—or even more—functional positions in a load-free manner. As a result, a variety of different customisations are possible, as will be explained in more detail below using details relating to the embodiments. The mechanical limits for these freedoms of movement are specified by the two mechanically defined end positions.

The driving takes place, for example, using a DC motor, and may in particular include a pivoting movement between the end positions. In particular, the entire embodiment of the electric door handle is designed to be free from a closing mechanism and/or free from an unlocking mechanism, as well as free from a microswitch, in particular. The sensor means described for determining the position of the hand grip may, for example, be an angle sensor, an absolute position sensor and/or a relative position sensor, which provides a corresponding physical and/or electrical detection functionality depending on the actual use situation.

It may be advantageous if, in an electric door handle, the handle bearing is designed to be free from a mechanical support in the travel position and/or gripping position and/or free from a lever mechanism. This further enhances the possibility of load-free positioning and reduces the outlay, design complexity and required installation space for the electric door handle. As a result, mechanical stops as well as friction between mechanically cooperating levers of a lever mechanism for intermediate positions are avoided, in particular.

It is also advantageous if, in an electric door handle of the present invention, the main body comprises a handle recess, wherein the first end position is arranged inside the handle recess and the second end position is arranged outside the handle recess. The hand grip may therefore be moved into the handle recess and out of the handle recess. In this case, too, this is a pivoting movement, in particular, wherein the pivot axis for this pivoting movement is preferably arranged outside the handle recess and inside the main body. This large range of movement results in a large number of independent load-free functional positions for the hand grip which will be explained in more detail below.

It is also advantageous if, in an electric door handle according to the invention, the sensor means is integrated in the electric drive. In particular, said sensor means may be an angle sensor which, for example in the case of an electric drive, may in particular be provided in the form of an electric stepper motor. Integrating the at least one sensor means in the electric drive makes it possible to design the remainder of the electric door handle so as to be free or substantially free from sensor means. This concentrates the required complexity on the electric drive and enhances the advantages—already explained multiple times above—of the compact and lightweight design and of the cost-effective manufacturing possibilities.

It is also advantageous if, in an electric door handle according to the invention, the main body comprises a first stop for the first end position and/or a second stop for the second end position. These are preferably mechanical stops which provide surface contact with a corresponding countersurface of the transmission device and/or of the hand grip. Preferably, however, these stops are not reached during normal operation, since positioning of the hand grip in the end positions is prevented by the corresponding counterforces and reset possibilities of the electric drive. The stops may preferably provide protection against undesired damage, in particular when violent force is applied to the hand grip, and/or to provide safety in the event of failure of the electric drive.

It is also advantageous if, in an electric door handle according to the invention, the electric drive comprises the transmission device for additional load-free positioning in at least one of the following positions that are at a distance from the end positions:
an unlocking position between the gripping position and the second end position,
an indicative position,
a defensive position against mechanical loading of the hand grip,
a protective position between the travel position and the first end position.

The list given above is not exhaustive. In particular, the individual positions are correlated with a first end position inside a handle recess and a second end position outside a handle recess of the main body. The unlocking position constitutes the end of an unlocking movement of the hand grip out of the gripping position, as will be explained in greater detail below. In its positioning, the unlocking position performs a signalling function, which, for example, indicates an unlocking mechanism that it should unlock the vehicle door in an electrical manner. An indicative position allows for communication between the user of the electric door handle and the vehicle. For example, visualisation may take place in that the hand grip is moved by the electric drive into an indicative position. This makes it possible, for example, to indicate that the vehicle is not yet locked or another functional situation has or has not yet occurred. For example, it is possible for the indicative position to inform the driver that a light situation at the vehicle, a locking function or the like has or has not been achieved. Conversely, it is also possible for signalling to be provided to the vehicle in the opposite direction by means of a movement of the user of the electric door handle, for example by means of the user pushing the hand grip along the range of movement. For example, the door handle being pushed multiple times may be used as an output signal to lock the vehicle. Separate sensors, such as touch-sensitive elements in the region of the door handle, can be avoided in this way, such that an additional signalling functionality can be integrated in the electric door handle without additional design effort. A defensive position may, for example, provide defence against mechanical loading. For example, if a person is leaning on the vehicle against the hand grip, said hand grip can be moved into a defensive position, which is perceived, in particular, as a tapping movement on the body part leaning on the hand grip. Finally, a protective position is also possible, which can be produced by retracting into a handle recess between the travel position and the end position. For example, if the vehicle is in a crash situation or pre-crash situation, this protective position can increase the probability that the hand grip is not ripped off or otherwise damaged during the crash.

Additional advantages can be achieved if, in an electric door handle according to the present invention, the transmission device and the handle bearing form a pivot axis for a pivoting movement of the hand grip over at least part of the range of movement, in particular over the entire or substantially the entire range of movement. Said pivot axis preferably lies within the main body and outside a handle recess. The pivoting movement allows for a particularly compact design and may additionally or alternatively be combined with a translational movement.

Another object of the present invention is a control method for a controlled movement of a hand grip of an electric door handle according to the invention, comprising the following steps:
ascertaining the current position of the hand grip within the range of movement,
determining a target position of the hand grip within the range of movement,
moving the hand grip into the target position within the range of movement by applying a movement force by means of the electric drive,
holding the hand grip in the target position reached with a holding force by means of the electric drive.

A control method according to the invention brings the same advantages as those explained in detail with reference to an electric door handle. The current position of the hand grip is ascertained, in particular, using the sensor means. The target position may, for example, be determined by means of a specification of a control system of the vehicle. For example, the hand grip may be in a travel position while the user of the vehicle is approaching the vehicle. The target position may be determined as the gripping position in a control method according to the invention if an action of the user of the vehicle is detected or if it is detected that the user is merely approaching with a key in their pocket. Subsequently, the hand grip is moved into said target position, for example in the form of the gripping position. For this movement, the electric drive applies the correspondingly required movement force to the hand grip. As soon as the hand grip has reached the target position, said position is only stable as load-free positioning as long as the electric drive is applying the correspondingly required holding force. Here, again, it is readily apparent how freely variable both the positioning and the application of force are in the relevant target position of the hand grip designed as a functional position.

It is advantageous if, in a control method according to the invention, when an externally applied activation force is detected for moving the hand grip out of the target position, in particular in the form of the gripping position, a defined counterforce is generated by means of the electric drive counter to the activation force. For example, it is possible that the hand grip is gripped by the user and moved into an unlocking position. The defined counterforce is therefore a defined resistance to said movement, which can be perceived by the user as a lightness or heaviness of the hand grip. In other words, it becomes possible to set the force characteristics during movement of the hand grip in a variable manner and, in particular, to reproduce different mechanical characteristics by applying different counterforce curves of the electric drive. The counterforce and thus the characteristics during movement of the door handle is therefore designed to be freely adjustable.

Additional advantages can be achieved if, in a control method according to the invention, the counterforce is lower than the activation force over part of the movement of the hand grip so as to allow for the defined movement of the hand grip. This therefore makes it possible to generate a resulting force that permits the desired movement, in particular in consideration of a maximum permitted movement speed. In this case, too, it is again possible to set and electronically control force characteristics and/or movement characteristics. Of course, it is possible for the counterforce to not be constant, but rather be provided so as to be variable along a curve in order, for example, to electronically reproduce a mechanical clicking sensation of mechanical unlocking kinematics via an increase.

Additional advantages can be achieved if, in a control method according to the invention, the movement force, the holding force and/or, in particular, a counterforce is adapted specifically for at least one of the following usage variants:
type of the vehicle,
make of the vehicle,
position of the vehicle door,
benefits to the person.

The list given above is not exhaustive. For example, door handles of varying degrees of heaviness can be imitated for different types of vehicle. A door handle for an SUV can thus be provided with heavier characteristics by means of the electric drive, whereas a compact car is provided with lighter characteristics by the same electric drive. Here, it is possible to use the same electric door handle without this design identity becoming apparent during use. Furthermore, different characteristics can be set for the electric door handle for different manufacturers of the vehicle, and thus different makes. It is also possible to provide different characteristics for different vehicle doors on one and the same vehicle. For example, if child seats are mounted on the back seats, the electric door handle on the associated rear vehicle doors can be designed to be more lightweight than on the front vehicle doors for the parents. In addition, an adaptation and thus customisation can be provided for different users, who are identifiable, for example, by keys of the vehicle assigned to persons.

Additional advantages can be achieved if, in a control method according to the invention, the curve of the activation force and/or the curve of the pulling speed of the hand grip is ascertained throughout the movement of the hand grip under the action of the activation force. This thus produces a live measurement and/or real-time measurement that can be coupled back into the control method. It is therefore possible to adapt to the current situation in a simple and cost-effective manner, such that, in particular, mechanical damage can be prevented and/or an undesired end position can be prevented from being reached in a highly effective manner.

It is also advantageous if, in a control method according to the invention, a movement duration is ascertained, in particular for the movement from the current position of the hand grip into the target position of the hand grip. The movement duration may therefore be monitored and preferably compared with a predefined maximum movement duration. If, for example, the movement from the gripping position into the travel position is too slow, this may be associated with a trapping situation. This makes it possible to detect such a situation without additional trapping sensors and thus to provide the required safeguard against trapping. In addition, if, for example, movement is too slow in the extension direction, it can be established that there may possibly be an icing situation, which can be countered with a defined de-icing movement of the electric door handle.

Additional advantages can be achieved if, in a control method according to the invention, a crash situation and/or a pre-crash situation is detected and a crash position and/or a pre-crash position is moved to as the target position for the hand grip. In particular, a distinction is made between pre-crash and crash, such that, in the pre-crash situation, a protective position can be assumed and then maintained throughout the crash situation to prevent the hand grip from being ripped off or damaged. At the end of the crash, the hand grips may automatically be extended into a gripping position in order, for example, to make it easier for rescue workers rushing to the scene to gain access into the vehicle. It is also possible for different protective positions to be assumed for the different doors, in order to further increase the probability of accessibility being as easy as possible.

It is also advantageous if, in a control method according to the invention, an indicative position is moved to as the target position in order to output a visual and/or haptic signal. Said visual and/or haptic signal may represent both the position alone as well as the movement into said position. For example, a tapping movement can be performed with the hand grip and perceived haptically by the user. In addition, an optical waving movement or movement into a defined recognisable waving position can add a signalling functionality to the control method in this case.

It is also advantageous if, in a control method according to the invention, a movement of the hand grip that is detected as a signal input is produced by introducing an activation force. As has already been explained, signalling in the opposite direction from the user to the vehicle is possible here. For example, functions of the vehicle, such as locking, activation of a parking light, opening of a boot, closing of the windows or opening or closing of other doors, can be signalled here as a function request. It may additionally be possible for the electric drive to operate as a generator in order to be able to provide the functionality described even in a de-energised situation, for example in cooperation with an electrical capacitor.

Another object of the present invention is a calibration method for calibrating an electric door handle according to the invention for use in a control method according to the invention, comprising the following steps:
detecting a position signal of a current position of the hand grip,
determining a current position of the hand grip in relation to at least one of the two end positions,
relating the current position signal to the determined current position of the hand grip.

As such, a calibration method according to the invention brings the same advantages as those described in detail in relation to an electric hand grip according to the invention and a control method according to the invention. The position to be detected can also be actively moved to. In the simplest case, this position may be one or even both of the end positions. However, it is also possible to deliberately move to a calibration position, which lies between the end positions and can be verified by means of separate checking means. The desired calibrated position is preferably as flush as possible with the outside of the vehicle skin of the vehicle, for example in the travel position.

A calibration method of this kind can be further developed in that the current position is determined in at least one of the following ways:
using a checking means for immobilising the hand grip,
camera images, in particular from a camera device fixed to the vehicle.

The list given above is not exhaustive. For example, checking means can be used which ensure a defined, flush positioning of the hand grip with the outer skin of the vehicle. For example, an adhesive tape may be guided over the hand grip such that a temporary end position is specified for this calibration situation in a mechanically defined manner. In addition, camera images may be evaluated in order to establish, during a service run from the first end position towards the second end position, when a flush orientation with the outer skin of the vehicle is possible and thus when the travel position can be set.

### BRIEF DESCRIPTION OF THE SEVERAL VIEWS OF THE DRAWINGS

Additional advantages, features and details of the invention are apparent from the following description, in which exemplary embodiments of the invention are described in detail with reference to the drawings. The features mentioned in the claims and in the description may be essential to the invention individually or in any combination. In the schematic drawings:

FIG. 1 shows an embodiment of an electric door handle according to the invention in the travel position,

FIG. 2 shows the embodiment from FIG. 1 in the first end position,

FIG. 3 shows the embodiment from FIGS. 1 and 2 in the second end position,

FIG. 4 shows the embodiment from FIGS. 1 to 3 in the gripping position,

FIG. 5 shows the embodiment from FIGS. 1 to 4 in an indicative position,

FIG. 6 shows the embodiment from FIGS. 1 to 5 in a protective position,

FIG. 7 shows the embodiment from FIGS. 1 to 6 in a calibration situation,

FIG. 8 shows the course of a force-displacement curve during use of an electric door handle, and

FIG. 9 shows the time curve of the individual positions in one example,

FIG. 10 shows a representation of an electric door handle according to the invention with a layer of ice,

FIG. 11 shows the situation from FIG. 10 during de-icing,

FIG. 12 shows a possible movement curve in a method according to the invention,

FIG. 13 shows another possible movement curve in a method according to the invention,

FIG. 14 shows another possible movement curve in a method according to the invention,

FIG. 15 shows another possible movement curve in a method according to the invention, and

FIG. 16 shows another possible movement curve in a method according to the invention.

### DESCRIPTION OF SPECIFIC EMBODIMENTS OF THE INVENTION

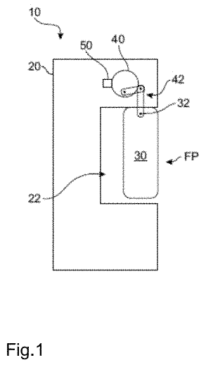

FIGS. 1 to 9 schematically illustrate a particular form of electric door handle, in particular without a mechanically defined zero position. An electric door handle 10 of this kind can particularly advantageously be used for a method according to the invention. However, in principle, classic electric door handles 10 may also be provided for a method according to the invention.

FIG. 1 is a schematic representation of a door handle 100 that can be fitted via a main body 20 on a vehicle. A handle recess 22 in which the hand grip 30 is arranged so as to be flush with the outer skin of the vehicle in the travel position shown is formed here in the main body 20. In order for the hand grip 30 to be movable, a handle bearing 32 is coupled here to a transmission device 42, such that a movement into desired target positions for the hand grip 30 is possible by means of an electric drive 40. Here, the position detection is given by a sensor means 50, for example in the form of an angle sensor.

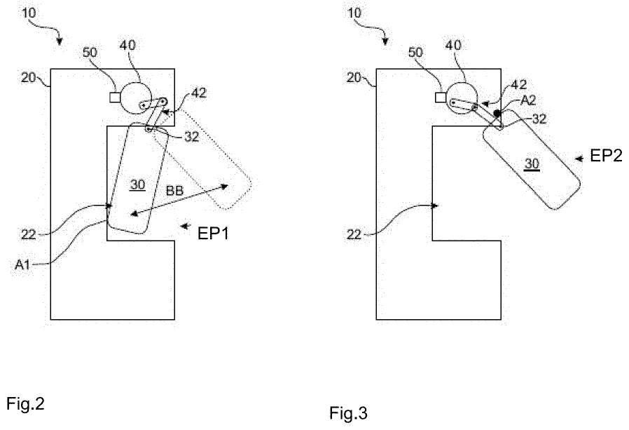

FIGS. 2 and 3 are schematic representations of two possible end positions EP1 and EP2. FIG. 2 shows the correlation between these two end positions EP1 and EP2, which specify the maximum range of movement BB. In order to specify the end positions EP1 and EP2 in a mechanically defined manner, a first stop A1 is specified in each case for the first end position EP1 and a second stop A2 is specified in each case for the second end position EP2. During normal operation of the electric door handle 10, these two end positions EP1 and EP2 should advantageously be understood to be mechanical protection positions that are preferably never assumed or only assumed in exceptional situations.

FIG. 4 shows a gripping position GP, in which it is possible, for example, to reach into or under the hand grip 30. In this position, an unlocking movement can now be performed, for example by using a gripping movement to pull the hand grip 30 further out of said gripping position GP, towards the second end position EP2.

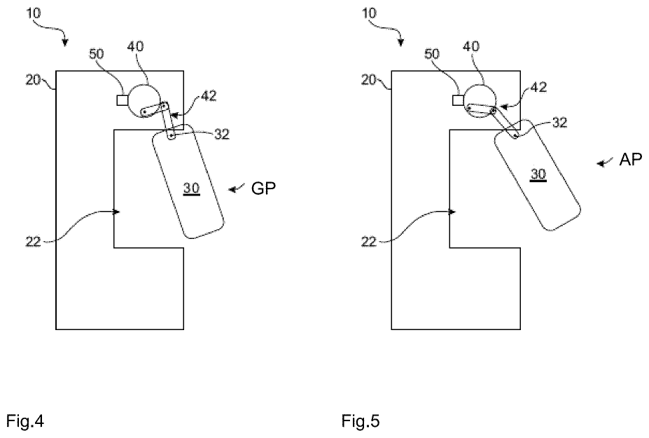

FIG. 5 shows a possible indicative position AP, which can be optically distinguished from the gripping position GP. A movement into this indicative position AP can output a signal to the user of the electric door handle 10 in the form of a waving movement.

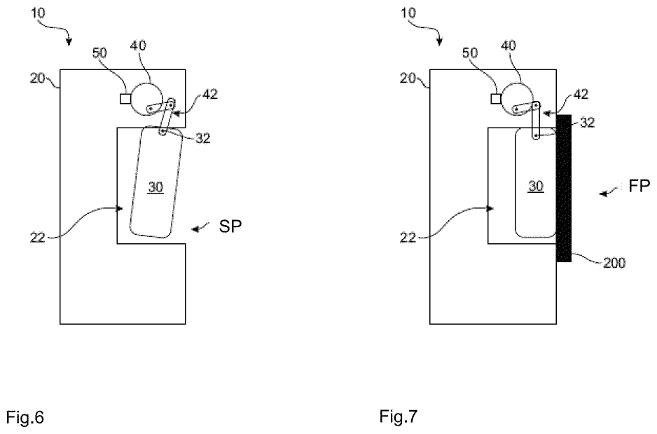

FIG. 6 schematically shows a protective position SP, in which the hand grip 30 is retracted further into the handle recess 22 in order to prevent undesired mechanical impairment or damage so as to be able to provide a greater protective effect.

FIG. 7 shows a possibility with a checking means 200, which temporarily limits a movement of the hand grip 30 here. If the hand grip 30 is then moved towards the second end position EP2 for a calibration method, the checking means 200 sets a new, temporarily mechanically defined end position as the travel position FP. As soon as this mechanically temporarily defined end position is reached, the calibration can set this position as the travel position FP and the checking means 200 can be removed again.

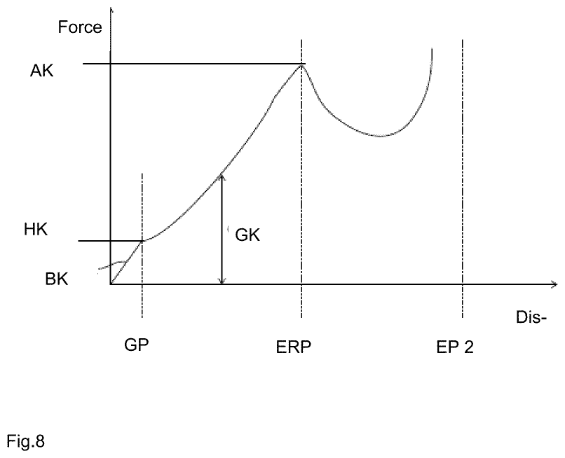

FIG. 8 schematically clearly shows how freely adjustable force characteristics can, for example, be set by means of an electric door handle 10 of this kind. Proceeding from a travel position FP (not shown in FIG. 8), a movement of the hand grip 30 into the gripping position GP takes place by means of a movement force BK. The hand grip 30 is held in this position by means of the holding force HK. If the user of the electric door handle 10 then grips the hand grip 30 and pulls it further out towards an unlocking position ERP, said user thus introduces an activation force AK until unlocking is achieved. In the process, the electric drive 40 applies a counterforce GK that increases with increasing displacement to the hand grip 30 until a maximum is reached at the unlocking position ERP. Here, either the movement of the hand grip 30 is terminated or a clicking sensation is produced for the user by means of a significant reduction in the counterforce GK over the remaining displacement path. Over the remaining displacement path, it can clearly be seen that the counterforce GK increases sharply even before the second end position EP2 is reached, in order to ensure a maximum blockade effect against said second end position EP2 actually being reached by the hand grip 30.

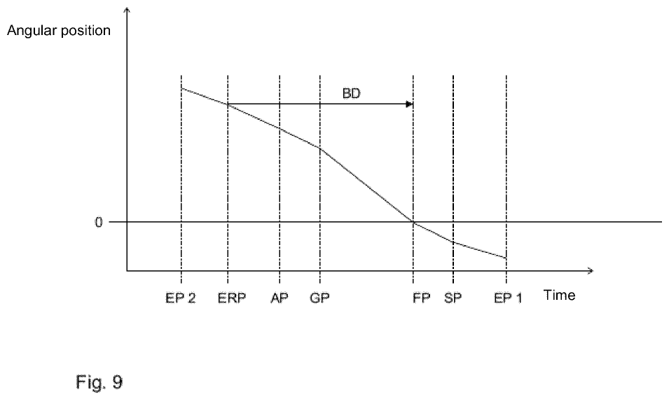

FIG. 9 is a schematic representation of how the individual angular positions can be assumed over time. For example, the travel position FP can be defined here as the zero position. In this movement, for example a service movement of the hand grip 30, the movement takes place from the second end position EP2 via an unlocking position ERP, an indicative position AP, a gripping position GP, a travel position FP and a protective position SP into the first end position EP1. Of particular importance is the range of the movement between the unlocking position ERP into the travel position FP and the movement duration BD required for this. If said movement duration is longer than a defined specification or a defined limit value, this may be due, for example, to a trapping situation, which can be detected by means of the time and position curve alone and without a separate trapping sensor.

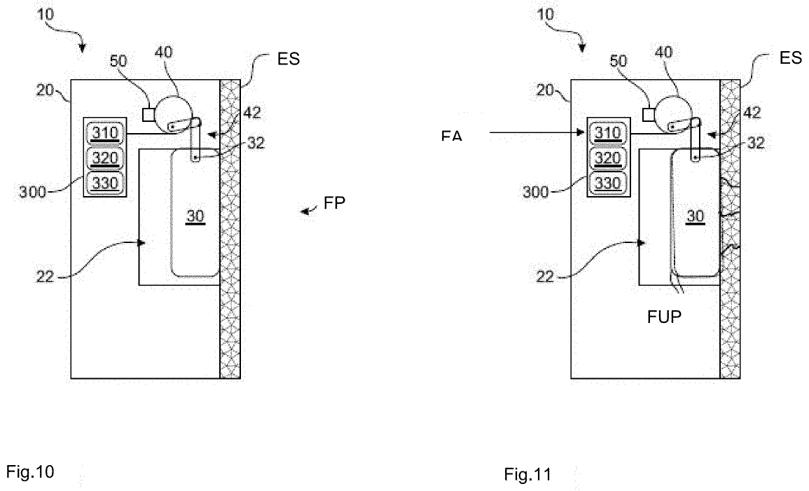

FIGS. 10 and 11 are schematic representations of the same electric door handle 10 from FIGS. 1 to 7. However, in these figures, the control device 300—which is also present in the embodiments of FIGS. 1 and 7—is also shown. This control device 300 comprises a determining module 310, for example for determining the travel position FP as the current position of the hand grip 30 in FIG. 10. Subsequently, it is possible to receive a function request FA using the receiving module 320 according to FIG. 11 and then, in this case, to perform a de-icing function as the secondary function using the performing module 330. FIG. 11 shows how the hand grip 30 is made to vibrate between two functional positions FUP and how, in this way, cracks are created in the layer of ice ES. Due to these cracks, the layer of ice ES falls off or is even actively blasted off from the surface of the electric door handle 10.

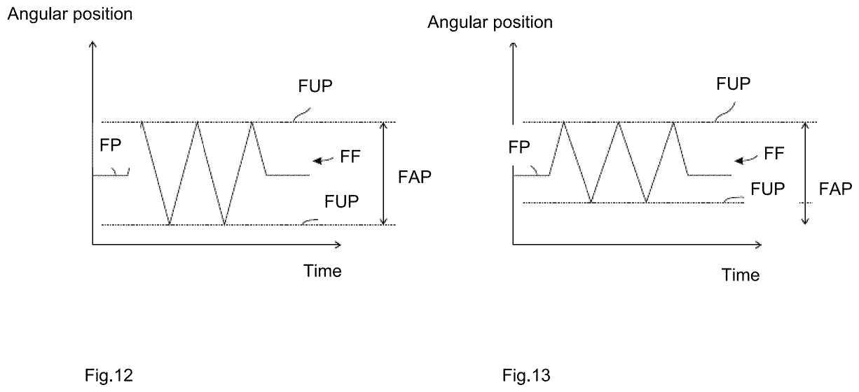

FIG. 12 schematically shows a curve of a functional movement of this kind, wherein a functional amplitude FAP with a constant functional frequency FF can be run through proceeding from the travel position FP in an oscillating manner between two functional positions FUP. In FIG. 13, the functional amplitude FAP has visibly been reduced, with the lower functional position FUP being different from in FIG. 12. Here, the functional movement may be an alternative or subsequent alternating functional movement.

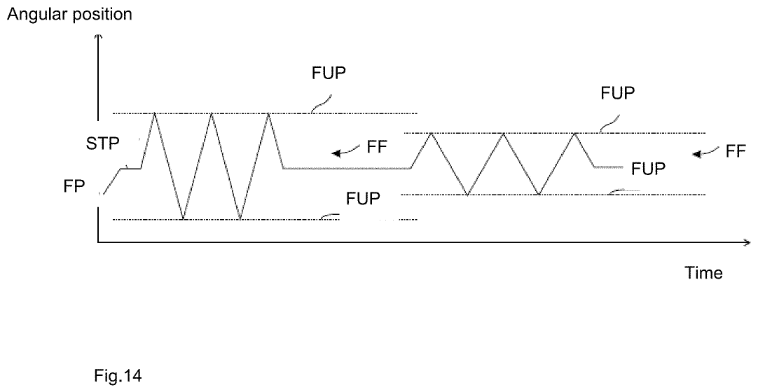

FIG. 14 schematically shows how various functional movements one after the other can be combined with one another after a wait time. Here, both the functional amplitude FAP and the functional frequency FF change between the two partial functional movements.

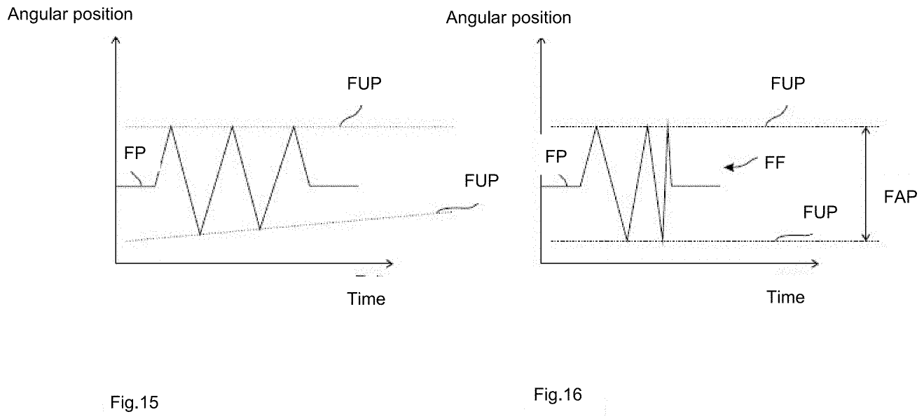

FIG. 15 and FIG. 16 show two examples of a so-called sweep. FIG. 15 shows a lower functional position FUP that varies over time such that the functional amplitude FAP also changes accordingly. FIG. 16 shows a sweep across the frequency range while the functional amplitude FAP stays the same.

The explanation given above merely serves to provide examples. Of course, individual features of the embodiments may be freely combined with one another, provided that this is technically feasible, without departing from the scope of the present invention.

### REFERENCES

10 Electric door handle
20 Main body
22 Handle recess
30 Hand grip
32 Handle bearing
40 Electric drive
42 Transmission device
50 Sensor means
100 Vehicle door
200 Checking means
300 Control device
310 Determining module
320 Receiving module
330 Performing module
BK Movement force
HK Holding force
AK Activation force
GK Counterforce
BD Movement duration
BB Range of movement
GP Gripping position
FP Travel position
AP Indicative position
SP Protective position
ABP Defensive position
ERP Unlocking position
EP1 First end position
EP2 Second end position
A1 First stop
A2 Second stop
SA Pivot axis
ES Layer of ice
FA Function request
FUP Functional position
STP Start position
FF Functional frequency
FAP Functional amplitude

What is claimed is:

1. Method for performing an alternating functional movement for producing a secondary function with a hand grip (30) of an electric door handle (10) of a vehicle door (100), comprising the following steps:
receiving a function request (FA) for activating the secondary function,
performing the alternating functional movement, wherein the hand grip (30) is moved back and forth multiple times between at least two different functional positions (FUP).

2. Method according to claim 1, characterised in that the secondary function is at least one of the following:
de-icing of the hand grip (30),
haptic signalling to the user of the hand grip (30),
acoustic signalling to the surroundings of the vehicle (100).

3. Method according to claim 1, characterised in that the alternating functional movement moves the hand grip (30) back and forth between the at least two different functional positions (FUP) at a defined functional frequency (FF) and/or a defined functional amplitude (FAP).

4. Method according to claim 3, characterised in that the functional frequency (FF) and/or the functional amplitude (FAP) changes over the course of the functional movement.

5. Method according to claim 1, characterised in that the functional movement is divided into a first partial functional movement, in which the hand grip (30) is moved back and forth multiple times between two different functional positions (FUP), and a second partial functional movement, in which the hand grip (30) is moved back and forth multiple times between two different functional positions (FUP) which differ from at least one functional position (FUP) of the first partial functional movement.

6. Method according to claim 1, characterised in that the alternating functional movement generates a vibration of the hand grip (30) between at least two different functional positions (FUP).

7. Method according to claim 1, characterised in that the hand grip (30) is moved into a start position (STP) before the alternating functional movement is performed.

8. Method according to claim 1, characterised in that the alternating functional movement is performed again after the alternating functional movement is performed, in particular after a wait time.

9. Method according to claim 8, characterised in that at least one movement parameter is changed for the subsequent alternating functional movement, in particular one of the following parameters:
at least one functional position (FUP),
the movement frequency,
the movement amplitude,
the movement direction.

10. Method according to claim 1, characterised in that a test movement takes place with the hand grip (30) for receiving the function request (FA).

11. Method according to claim 1, characterised in that a plausibility check, in particular using environmental parameters and/or vehicle parameters, takes place before the alternating functional movement is performed.

12. Method according to claim 1, characterised in that the alternating functional movement corresponds at least in part to a natural frequency of a neighbouring component and/or a layer of ice (ES).

13. Method according to claim 1, characterised in that the functional movement is simultaneously and/or subsequently also performed on other electric door handles (10) of the vehicle (100).

14. Method according to claim 1, characterised in that the functional movements for at least two electric door handles (10) differ from one another.

15. Electric door handle (10) for a vehicle door (100), comprising a main body (20) for arrangement in the vehicle door (100), wherein a hand grip (30) is mounted on the main body (20) so as to be movable within a range of movement (BB) between a mechanically defined first end position (EP1) and a mechanically defined second end position (EP2) by means of a handle bearing (32), further comprising an electric drive (40) for a movement of the hand grip (30) between the two end positions (EP1, EP2) and at least one sensor means (50) for detecting the position of the hand grip (30) between the two end positions (EP1, EP2), wherein the electric drive (40) comprises a transmission device (42) for load-free positioning of the hand grip (30) in a gripping position (GP) of the hand grip (30) at a distance from the end positions (EP1, EP2) and for load-free positioning of the hand grip (30) in a travel position (FP) at a distance from the end positions (EP1, EP2) and from the gripping position (GP), further comprising a control device (300) for performing an alternating functional movement for producing a secondary function with a hand grip (30) of an electric door handle (10) of a vehicle door (100), said control device comprising a determining module (310) for determining a current position of the hand grip (30) within a range of movement (BB) between a first mechanically defined end position (EP1) and a second mechanically defined end position (EP2), a receiving module (320) for receiving a function request (FA) for activating the secondary function, and a performing module (330) for performing the alternating functional movement, wherein the hand grip (30) is moved back and forth multiple times between at least two different functional positions (FUP), wherein the determining module (310), the receiving module (320) and/or the performing module (330) are designed, in particular, to carry out a method having the features of claim 1.
